(19) United States
(12) Patent Application Publication
(10) Pub. No.: US 2011/0281967 A1
(43) Pub. Date: Nov. 17, 2011

(54) Encapsulant for Inkjet Print Head

(75) Inventor: Susan Lillian Krawiec, Lawrence, MA (US)

(73) Assignee: Henkel Corporation

(21) Appl. No.: 13/190,574

(22) Filed: Jul. 26, 2011

Related U.S. Application Data
(63) Continuation of application No. PCT/US2010/023031, filed on Feb. 3, 2010.
(60) Provisional application No. 61/149,366, filed on Feb. 3, 2009.

(51) Int. Cl. C08L 71/02; C08J 3/28; C08L 75/16

(52) U.S. Cl. 522/96; 522/144

(57) ABSTRACT

A UV curable composition suitable for use as an encapsulant to protect silicon semiconductor dies and their electrical bonding on digital print heads comprises an acrylate and/or methacrylate ((meth)acrylate) oligomer, preferably a difunctional oligomer; a diluent, preferably a (meth)acrylate; a tri-functional or tetra-functional thiol; a polypropylene oxide/butylene oxide block polymer; and a photoinitiator.

### CROSS-REFERENCE TO RELATED APPLICATIONS

This application is a continuation of International Application No. PCT/US2010/023031 filed Feb. 3, 2010, which claims the benefit of U.S. Provisional Patent Application No. 61/149,366 filed Feb. 3, 2009, the contents of both of which are incorporated herein by reference.

### BACKGROUND OF THE INVENTION

This invention relates to an encapsulant for protecting the tab and wire interconnections on silicon semiconductor die microfluidic devices in an inkjet print head from mechanical and fluid damage.

Print heads are devices that eject fluids in the form of drops, which drops compose desired characters or patterns on a receiving medium. A print head is mounted on a printing apparatus and either the print head is moved relative to a print receiving medium or a print receiving medium is moved relative to the print head such that the print receiving medium is scanned by the print head. Print heads include a plurality of selectively operable fluid ejection devices, typically disposed in a line. Certain of the elements include silicon semiconductor dies, the surfaces of the dies, electrical bonding between the dies and substrates, and plastic substrates. The silicon dies and bonding are encapsulated in a material to protect them from the chemical effects of the ink and the mechanical stresses of the movement of the print head. Currently used encapsulants do not have optimized resistance to the inks and it would be a benefit to the industry to optimize the ink resistance for the encapsulants.

### SUMMARY OF THE INVENTION

This invention relates to a UV curable composition suitable for use as an encapsulant to protect silicon semiconductor dies and their electrical bonding on print heads. The encapsulant comprises an acrylate and/or methacrylate (hereinafter “(meth)acrylate”) oligomer, preferably a difunctional oligomer; a diluent, preferably a (meth)acrylate; a tri-functional or tetra-functional thiol; a poly(propylene)oxide/poly(butylene)oxide block copolymer; and a photoinitiator. The encapsulant may further comprise one or more silanes to additional enhance ink resistance, and optionally one or more stabilizers, inhibitors, adhesion promoters, fillers, peroxides, and defoamers.

### DETAILED DESCRIPTION OF THE INVENTION

Suitable acrylate or methacrylate oligomers include urethane, acrylate, or epoxy oligomers end-capped with an acrylate or a methacrylate. In one embodiment, the oligomer is an aromatic urethane methacrylate. The acrylate and/or methacrylate oligomers will be present in an amount ranging from 22 to 60 percent by weight of the total composition.

Suitable diluents are selected from monofunctional acrylates and difunctional acrylates and in one embodiment the diluent is isobornyl methacrylate. Other diluents include 2-phenoxyethyl acrylate and tricyclodecane dimethanol diacrylate. The diluent will be present in an amount ranging from 30 to 55 percent by weight of the total composition.

In many cases, the semiconductor components are situated on a flexible substrate, which requires that the encapsulant formulation have sufficient mechanical toughness. Suitable tougheners include tri- and tetrafunctional thiols. In one embodiment, the thiol is trimethylolpropane tris(3-mercaptopropionate). Other suitable thiols include pentaerythritol tetra-3-mercaptopropionate. The thiol will be present in an amount ranging from 2.5 to 8.8 percent by weight of the total composition.

Other suitable tougheners are block copolymers. In one embodiment, the block copolymer is poly(ethylene)oxide/poly(butylene)oxide block copolymer with a 1:1 molar ratio of ethyleneoxide to butyleneoxide. In practice, the ratio may vary slightly from 1:1, and insignificant differences in the ratio are intended to mean a 1:1 molar ratio. The block copolymer will be present in an amount ranging from 1 to 25 percent by weight of the total composition.

In one embodiment, the encapsulant will further comprise a silane. Suitable silanes include 2-(3,4 epoxycyclohexyl)ethyltrimethoxysilane, 2-(aminoethyl) 3-amino-propyltriethoxy silane, 2-(3,4-epoxycyclohexyl)ethyltriethoxysilane, (3-glycidoxy-propyl)trimethoxysilane, (3-glycidoxypropyl)triethoxysilane, 5,6-epoxyhexyltriethoxy-silane, 3-glycidoxypropyl)methyldiethoxysilane, (3-glycidoxypropyl)dimethylethoxy-silane, 3-mercaptopropyltrimethoxysilane, 3-aminopropyltriethoxysilane, 3-ureido-propyltriethoxysilane, 2-(diphenylphosphino)ethyltriethoxysilane, 3-isocyanato-propyltriethoxysilane, methyltriethoxysilane, isobutyltrimethoxysilane, vinyltri-methoxysilane, 3-methacryloxpropyltrimethoxysilane, 3-[2-(vinylbenzyl-amino)-ethylamino]proplytrimethoxysilane dydrochloride, 3-glycidoxypropyltrimethoxy-silane. The silane will be present in an amount ranging from 0.5 to 2.0 percent by weight of the total composition.

Suitable photoinitiators include those sold under the trademark Irgacure by Ciba Specialty Chemicals. Other suitable photoinitiators include hydroxyl-cyclohexyl-phenyl ketone; phosphine oxide, phenyl bis (2,3,6 trimethyl benzoyl); and alpha, alpha dimethoxy alpha phenylacetophenone. The photoinitiator will be present in an amount ranging from 0.8 to 5.0 percent by weight of the total composition.

In addition to the above mentioned components, the encapsulant composition optionally may contain stabilizers, adhesion promoters, fillers, defoamers, and other additives known for use in encapsulant compositions.

### EXAMPLES

### Example 1

This Example shows the performance of encapsulant compositions containing various toughening agents measured by the level of chemical resistance and the storage modulus of the cured encapsulant.

The chemical resistance was measured as follows. Formulations were prepared to contain the components shown in the table below. The liquid formulations were poured into disk-shaped molds of uniform dimensions and cured by ultraviolet (UV) exposure using a 300 Watt per inch UV source. The cured encapsulants were released from the molds and formed disks of uniform dimensions. The disks were weighed and immersed in aqueous cyan ink at 60° C. or 90° C. At intervals of 7, 14, and 28 days, the disks were removed from the fluid, patted dry with paper towels, and re-weighed. The aged weight was compared to the initial weight and the percent weight change calculated. The dynamic mechanical analysis (DMA) storage modulus was measured on cured coupons that were not immersion tested. The components of the formulations in weight percent, the percent weight change, and the DMA are recorded in the following table and show that formulation A containing the poly(propylene)oxide/-poly(butylene)oxide block copolymer had the lowest weight gain, and therefore the greatest resistance to the ink, compared to the comparative formulations B, C, and D. Formulation A also had a low dynamic mechanical analysis (DMA) storage modulus (indicating high flexibility).

TABLE 1
FORMULATIONS AND PERFORMANCE RESULTS

| | A | B | C | D |
|---|---|---|---|---|
| FORMULATION COMPONENTS | | | | |
| polyurethane methacrylate oligomer | 41.2 | 41.2 | 39.1 | 43.4 |
| isobornyl methacrylate | 48.0 | 48.0 | 45.5 | 50.5 |
| trimethyolpropane tris(3- | 4.9 | 4.9 | 4.6 | 5.1 |
| mercaptopropionate) | | | | |
| alpha, alpha-dimethoxy-alpha- | 0.9 | 0.9 | 0.8 | 0.9 |
| phenylacetophenone | | | | |
| polybutadiene diacrylate | | 5 | | |
| polybutadiene maleic anhydride adduct | | | 10 | |
| poly(ethylene)oxide/ | 5 | | | |
| poly(butylene)oxide block copolymer | | | | |
| PERCENT WEIGHT CHANGE (%) | | | | |
| after immersion of 7 days | 3.2 | 3.2 | 5.9 | 3.1 |
| 14 days | 3.4 | 4.0 | 6.9 | 3.7 |
| 28 days | 3.8 | 4.9 | 8.3 | 4.5 |
| STORAGE MODULUS | 635 | 1144 | 600 | 1339 |
| at 25° C. (MPa) | | | | |

### Example 2

Additional samples were prepared and tested according to Example 1. The formulations and results are reported in the following tables.

TABLE 2
FORMULATIONS IN WEIGHT PERCENT

| FORMULATION COMPONENTS | E | F | G | H | I |
|---|---|---|---|---|---|
| polyurethane oligomer | 22.82 | 34.82 | 22.50 | 27.55 | 21.36 |
| isobornyl methacrylate | 36.82 | 40.53 | 36.05 | 32.07 | 33.95 |
| trimethyolpropane tris(3- | 2.68 | 4.10 | 2.65 | 3.24 | 2.51 |
| mercaptopropionate) | | | | | |
| alpha, alpha-dimethoxy- | 0.49 | 0.75 | 0.48 | 0.59 | 0.46 |
| alpha-phenylacetophenone | | | | | |
| gamma glycidoxypropyl- | 0.57 | 0.96 | 0.89 | 0.76 | 0.86 |
| trimethoxy silane | | | | | |
| 1,1 di(tert-butylperoxide) 3,3 | 0.57 | | 0.56 | | 0.52 |
| 5, trimethylcyclohexane | | | | | |
| fumed silica thixotrope | 3.36 | | 3.32 | | 3.06 |
| phenyl bis (2,4,6,trimethyl | 1.75 | 2.39 | 1.73 | 1.89 | 1.59 |
| benzoyl) phosphine oxide | | | | | |
| 1-hydroxy-cyclohexyl- | 1.16 | 1.59 | 1.14 | 1.26 | 1.05 |
| phenyl-ketone | | | | | |
| poly(ethylene)oxide/poly- | | 14.83 | | 11.74 | 3.55 |
| (butylene)oxide block | | | | | |
| copolymer | | | | | |
| non-fumed silica | 30.00 | | 29.58 | 20.00 | 30.01 |
| beta (3,4 epoxycyclohexyl)- | | | 0.89 | 0.70 | 0.86 |
| ethyltrimethoxysilane | | | | | |
| N-(2 aminoethyl) 3- | | | 0.20 | 0.16 | 0.19 |
| aminopropyl-triethoxy silane | | | | | |

TABLE 3

| | FORMULATION | | | | | | | |
|---|---|---|---|---|---|---|---|---|
| | E | | F | | G | | H | |
| | PERCENT CHANGE IN WEIGHT AFTER IMMERSION | | | | | | | |
| Days Immersed at | 7 | 28 | 7 | 28 | 7 | 28 | 7 | 28 |
| 60° C. | | | | | | | | |
| IMMERSION | | | | | | | | |
| MEDIUM | | | | | | | | |
| American Ink Jet | 3.94 | 4.07 | 9.28 | 9.39 | 3.30 | 3.44 | 7.09 | 6.09 |
| Magenta # 69 | | | | | | | | |
| EMA-4613 | | | | | | | | |
| Aldrich | −0.10 | −0.31 | −0.73 | −0.57 | −0.50 | −0.76 | −1.19 | −1.03 |
| 1000 MW | | | | | | | | |
| polyethylene | | | | | | | | |
| glycol | | | | | | | | |
| Water 50%, | 0.58 | 0.72 | 2.40 | 3.28 | 0.09 | 0.17 | 1.79 | 1.65 |
| ethylene glycol | | | | | | | | |
| 40%, 2- | | | | | | | | |
| pyrrolidone 10% | | | | | | | | |
| (by weight) | | | | | | | | |

TABLE 4
MODULUS AND GLASS TRANSITION TEMPERATURE (Tg)

| | E | F | G | H | I |
|---|---|---|---|---|---|
| Modulus (MPa) | 2400 | 91 | 2260 | 91 | 488 |
| Tg (° C.) | 85 | 50 | 81 | 49 | 68 |

Comparison of Formulation Examples:

Formulation F contains poly(ethylene)oxide/poly(butylene)oxide block copolymer and has low modulus and low Tg, indicating high flexibility. Formulation E contains no poly(ethylene)oxide/poly(butylene)oxide block copolymer and has high modulus and high Tg, indicating low flexibility. Formulation G contains no poly(ethylene)oxide/poly-(butylene)oxide block copolymer and has high modulus and high Tg, indicating low flexibility (similar to formulation E). Formulation H contains poly(ethylene)oxide/poly(butylene)oxide block copolymer and has low modulus and low Tg, indicating high flexibility (similar to formulation F). These results support the fact that the presence of the block copolymer lends flexibility to the formulation.

Formulation E (with no block copolymer) contains non-fumed silica and no silanes and has low percent weight change after immersion, indicating good ink resistance. Formulation F (with block copolymer) contains no non-fumed silica and no silanes and has high percent weight change after immersion, indicating low ink resistance. These results support the fact that the presence of the non-fumed silica acts as a barrier to fluids in the immersion and thus contributes to good ink resistance.

Formulation G (with no block copolymer) contains non-fumed silica and silanes and has a low percent weight change after immersion, indicating good ink resistance, even lower than formulation E (with block copolymer and with non-fumed silica), which does not contain this level of silane. These results support the fact that the presence of silane improves ink resistance.

Formulation H with block copolymer, non-fumed silica, and silane, has a moderate weight change after immersion, indicating more ink resistance than formulation F, but less than the ink resistance of G with no block copolymer.

These results indicate that the presence of the block copolymer is needed for flexibility and the presence of the non-fumed silica is needed for ink resistance. The results also indicate that the presence of silane further enhances ink resistance.

### Example 3

Additional formulations were prepared and tested as in Example 1. The formulation components and test results are reported in the following table and show that the block copolymer level has a large impact in reducing the storage modulus, but a smaller impact on the immersion weight change.

TABLE 5
FORMULATIONS IN WEIGHT PERCENT

| | J | K | L | M | N |
|---|---|---|---|---|---|
| FORMULATIONS IN | | | | | |
| WEIGHT PERCENT | | | | | |
| polyurethane methacrylate | 43.3 | 39.1 | 36.9 | 34.7 | 32.6 |
| oligomer | | | | | |
| isobornyl methacrylate | 50.4 | 45.5 | 43.0 | 40.4 | 37.9 |
| trimethyolpropane tris(3- | 5.1 | 4.6 | 4.3 | 4.1 | 3.8 |
| mercaptopropionate) | | | | | |
| alpha, alpha-dimethoxy- | 0.9 | 0.8 | 0.8 | 0.7 | 0.7 |
| alpha-phenylacetophenone | | | | | |
| poly(ethylene)oxide/ | | 10 | 15 | 20 | 25 |
| (poly)butylene- | | | | | |
| oxide block copolymer | | | | | |
| PERCENT WEIGHT | | | | | |
| CHANGE (%) | | | | | |
| after immersion at | | | | | |
| 60° C. for 7 days | | | | | |
| American Ink Jet | 1.4 | 2.3 | 3.1 | 3.8 | 4.6 |
| Aqueous cyan | | | | | |
| American Ink Jet | 6.0 | 7.2 | 8.2 | 9.6 | 10.4 |
| Magenta # 69EMA-4613 | | | | | |
| Water 50%, ethylene glycol 40%, | 0.9 | 1.5 | 2.0 | 2.5 | 3.1 |
| 2-pyrrolidone 10% | | | | | |
| STORAGE MODULUS | 1361 | 571 | 258 | 87 | 25 |
| AT 25° C. (MPA) | | | | | |
| TG AT TAN DELTA | 80 | 69 | 60 | 54 | 39 |
| PEAK (° C.) | | | | | |

1. An encapsulant composition comprising
an acrylate and/or methacrylate oligomer;
a monofunctional (meth)acrylate diluent;
a tri-functional or tetra-functional thiol;
a polypropylene oxide/butylene oxide block copolymer; and
a photoinitiator.

2. The encapsulant composition according to claim 1 in which the (meth)acrylate oligomer is an aromatic urethane polymer.

3. The encapsulant composition according to claim 1 further comprising a silane.

4. The encapsulant composition according to claim 3 in which the silane is present in an amount ranging from 0.5 to 2.0 percent by weight of the total composition.

5. The encapsulant composition according to claim 3 in which the (meth)acrylate oligomer is an aromatic urethane polymer.

6. The encapsulant composition according to claim 1 in which
the acrylate and/or methacrylate oligomer is present in an amount ranging from 22 to 60 percent by weight of the total composition;
the monofunctional (meth)acrylate diluent is present in an amount ranging from 30 to 55 percent by weight of the total composition;
the tri-functional or tetra-functional thiol is present in an amount ranging from 2.5 to 8.8 percent by weight of the total composition;
the polypropylene oxide/butylene oxide block copolymer is present in an amount ranging from 1 to 25 percent by weight of the total composition; and
the photoinitiator is present in an amount ranging from 0.8 to 5.0 percent by weight of the total composition.
